(19) United States
(12) Patent Application Publication
(10) Pub. No.: US 2009/0169117 A1
(43) Pub. Date: Jul. 2, 2009

(54) IMAGE ANALYZING METHOD

(75) Inventors: Takayuki BABA, Kawasaki (JP); Susumu ENDO, Kawasaki (JP); Shuichi SHIITANI, Kawasaki (JP); Yusuke UEHARA, Kawasaki (JP); Daiki MASUMOTO, Kawasaki (JP); Shigemi NAGATA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/340,739

(22) Filed: Dec. 21, 2008

(30) Foreign Application Priority Data
Dec. 26, 2007 (JP) 2007-333712

(51) Int. Cl. G06K 9/68

(52) U.S. Cl. 382/218

(57) ABSTRACT

According to an aspect of an embodiment, a method of operating an apparatus having a display device for analyzing a plurality of images each representing a similar item, includes the steps of: displaying the plurality of the images in parallel by the display device; enabling a user to select partial regions of the images such that each of the partial regions represents a similar portion of the each item; extracting information associated with each of the partial regions of the images; and displaying data of the information of each of the partial regions in parallel in a format different from that appeared in the images.

### BACKGROUND

1. Field of the Invention

The invention relates to a technique of detecting the correlation between an image and information on the image.

2. Description of the Related Art

In recent years, an image mining method has been developed as a technique of detecting information items obtained in accordance with the relationships between visual features of many images in an image group and association information items (text information and numerical value information) regarding the images. The image mining method includes a process of arranging images in a virtual three-dimensional space on the basis of various perspectives (in an ascending order of performance values, for example) so as to assist an user to find the relationships between visual features of the images and performance values while the user views the arranged images.

The image mining method may be used in fields of product design and manufacturing. For example, automobile manufacturers design engines of different shapes so as to analyze shapes of engines which attain excellent mileages. When the shapes of engines which attain excellent mileages are to be determined, pairs of information items, i.e., an image representing distribution of fuel concentration for one of the engines having different shapes and a mileage information item (performance value) regarding the image, are obtained. The user analyzes the pairs of the image and the mileage information item so as to obtain information derived from the relationships between the shapes of engines and performances. There are various examples of a process using the image mining such as a process of analyzing the relationships between various shapes of magnetic heads and performance values. A technique related to the above techniques is disclosed in Japanese Laid-open Patent Publication No. 2000-305940 discloses a related technique.

A product including a component A and a component B attached to each other by soldering is taken as an example. It is assumed that if attachment of components A and B is not properly performed by soldering, a product including the components A and B is determined as a defective product. When it is considered that a stress applied to a product relates to production of a nondefective product or a defective product, a number of samples of nondefective products and a number of samples of defective products are prepared in order to determine the correlation between the stress and the production of a nondefective product or a defective product. Images visually representing stresses applied to the samples and attribute data blocks of the nondefective products and the defective products which are associated with the images in advance are used to assist an user to find the relationship between the stress and the production of a nondefective product or a defective product. Here, it is assumed that the user views an image group including the nondefective products and defective products separately arranged, and finds a certain feature in a region of the image group. However, even if the user finds the relationship between visual features of the images and performance values of products (nondefective products or defective products, for example), when the relationship found by the user appears only in local regions of the images, the visual features of the images are merely qualitatively represented. For example, when the user find a certain feature in specific portions of images of nondefective products in the image group including the nondefective products and the defective products, the user merely presumes that the feature of the portions of the images may include some relationship which distinguishes between the nondefective products and the defective products. Therefore, the user cannot obtain the relationship between the feature of the portions of the images and association information items as detailed information.

### SUMMARY

According to an aspect of an embodiment, a method of operating an apparatus having a display device for analyzing a plurality of images each representing a similar item, includes the steps of: displaying the plurality of the images in parallel by the display device; enabling a user to select partial regions of the images such that each of the partial regions represents a similar portion of the each item; extracting information associated with each of the partial regions of the images; and displaying data of the information of each of the partial regions in parallel in a format different from that appeared in the images.

### BRIEF DESCRIPTION OF THE DRAWINGS

FIG. 1 is a diagram illustrating results of image processing according to an embodiment;

FIG. 2 is a block diagram illustrating a configuration of an image analyzing device;

FIG. 3 is a block diagram used to describe a function of the image analyzing device;

FIG. 4 is a diagram illustrating a configuration example of a performance value database;

FIG. 5 is a diagram illustrating one of image information items of this embodiment;

FIG. 6 is an enlarged view illustrating one of junction regions in the image information;

FIG. 7 is a diagram illustrating a display example of an image group arranged in a virtual three-dimensional space;

FIG. 8 is a flowchart illustrating a process of displaying feature values of regions in images selected by a user;

FIG. 9 is a diagram illustrating an example of a screen when a selection region in a selected image is selected;

FIG. 10 is a flowchart illustrating an operation of searching for similar regions;

FIG. 11 is a flowchart illustrating an operation of searching for candidates of the similar regions;

FIG. 12A is a diagram illustrating the searching operation;

FIG. 12B is a diagram illustrating the searching operation;

FIG. 13 is a diagram illustrating an example of the screen displaying the candidates of the similar regions;

FIG. 14 is a flowchart illustrating an operation of reducing the number of the candidates of the similar regions;

FIG. 15A, FIG. 15B, and FIG. 15C are diagrams used to describe the operation of reducing the number of the candidates of the similar regions;

FIG. 16 is a diagram illustrating an example of the screen displaying results of detection of the similar regions;

FIG. 17 is a diagram illustrating a configuration example of a color histogram;

FIG. 18 is a flowchart illustrating an operation of calculating correlation coefficients;

FIG. 19 is a distribution diagram obtained when the correlation coefficients are close to “1”;

FIG. 20 is a distribution diagram obtained when the correlation coefficients are close to “0”; and

FIG. 21 is a flowchart illustrating an operation of displaying a feature value in a region in an image selected by the user.

### DESCRIPTION OF THE PREFERRED EMBODIMENTS

An embodiment of the invention will now be described with reference to the accompanying drawings. Images to be processed in this embodiment are obtained as results of simulations, and more particularly, are results of simulations which obtain magnitudes of stresses generated when printed boards and components are attached to each other by soldering. Different colors in the images representing the results of the simulations correspond to different magnitudes of stress applied between the printed boards and the components attached to each other by soldering. A plurality of images of the embodiment each represents a similar item.

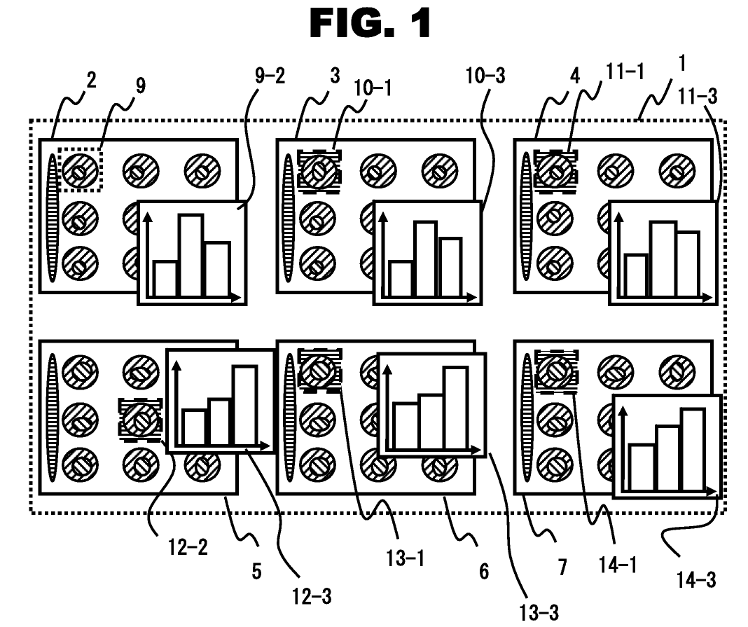

FIG. 1 is a diagram illustrating a result of image processing according to this embodiment. An image group 1 represents printed boards including components attached thereto by soldering. The image group 1 of this embodiment includes a plurality of images, and a variation among the images is small. The small variation among the images means small differences in size, direction, and brightness among the images representing objects. The image group 1 is stored in advance in a storage unit, for example. The images shown in FIG. 1 represent results of simulations in which stresses generated between the printed board and components are obtained. The plurality of images included in the image group 1 are obtained by photographing different products under an identical photographing condition. Under the identical photographing condition, angles and distances between a camera and the products and illumination are maintained stable. Image information items include appearances of the products and the images obtained as the results of simulations.

Images 2 to 7 represent printed boards including components attached thereto by soldering. The images 2 to 7 represent different products.

An image analyzing device of this embodiment performs the following processing on the image group 1. First, a user selects an arbitrary region in one of the images included in the image group 1. In FIG. 1, it is assumed that the user selects a region 9 in the image 2. The image analyzing device obtains a position information item, a size information item, and an image feature value of the region 9 in the image 2. The image feature includes a displayed color and a tone in the selected region in this embodiment. The feature value is determined by color, color distribution (coloration), distribution of a contour, pattern, and texture, for example. The feature value is represented by a multidimensional vector in this embodiment. Each of the dimensions represents the number of pixels of a predetermined color in the region, for example. Next, the image analyzing device obtains regions 10-1, 11-1, 12-2, 13-1, and 14-1 in the images 3 to 7 to be compared with the region 9 using position information items in images 3 to 7 corresponding to the position information item of the region 9, size information items in the images 3 to 7 corresponding to the size information of the region 9, and the feature value of the image in the region 9. Note that the regions in the images to be compared with the region 9 may be manually selected by the user, and in this embodiment, it is assumed that the region 12-2 of the image 5 is manually selected by the user, which will be described later. The image analyzing device displays the data of the information of each of the partial regions in parallel in a format different from that appeared in the images. For example, the image analyzing device displays histograms showing colors and tones of the regions 9, 10-1, 11-1, 12-2, 13-1, and 14-1 of the images 2 to 7. The displayed histograms represent feature values of the regions. The histograms show different aspects in accordance with types of object to be subjected to image analyzing and events to be analyzed. In FIG. 1, histograms 9-2, 10-3, 11-3, 12-3, 13-3, and 14-3 are displayed so as to correspond to the images 2 to 7, respectively.

As described above, the image analyzing device displays visual differences between the region in one of the images selected by the user and the regions in the other images corresponding to the region in the one of the images selected by the user as information items which can be compared with one another. Accordingly, the user finds the correlations between the visual differences and differences in performance with ease.

As described above, a method of operating the image analyzing device having a display device for analyzing a plurality of images each representing a similar item, includes the steps of: displaying the plurality of the images in parallel by the display device; enabling a user to select partial regions of the images such that each of the partial regions represents a similar portion of said each item; extracting information associated with each of the partial regions of the images; and displaying data of the information of each of the partial regions in parallel in a format different from that appeared in the images.

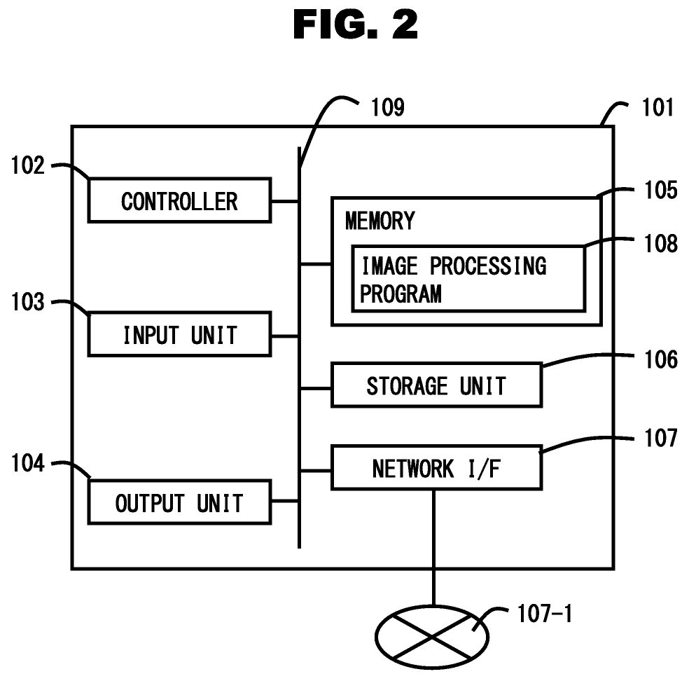

Referring now to FIG. 2, a configuration of the image analyzing device will be described. An image analyzing device 101 assists analysis of the relationship among regions in the images. The image analyzing device 101 includes a controller 102, an input unit 103, an output unit 104, a memory 105, a storage unit 106, and a network interface (network I/F) 107 which are connected to one another through a bus 109.

The controller 102 entirely controls the image analyzing device 101. The controller 102 is a central processing unit, for example. The controller 102 executes an image processing program 108 developed in the memory 105. The image processing program 108 allows the controller 102 to execute image processing.

The input unit 103 receives various instructions which are input by the user and which are to be supplied to the controller 102. The input unit 103 includes a keyboard, a mouse, and a touch panel. The instructions may be obtained through a network 107-1.

The output unit 104 outputs an image group to be analyzed and a result of calculation performed using the controller 102, for example. The output unit 104 is connected to a display device, for example, and the image group and the result of calculation performed using the controller 102 are displayed in the display device. Furthermore, the output unit 104 may output the image group and the calculation result through the network 107-1 to an external computer.

The memory 105 is a storage region in which the image processing program 108 which is executed using the controller 102 is developed. Furthermore, the memory 105 stores therein data representing a result of calculation performed using the controller 102, image data, and feature value data, for example. The memory 105 is a RAM (Random Access Memory), for example.

The storage unit 106 stores therein the image processing program 108 and image data, for example. The storage unit 106 is a hard disk device, for example.

The network I/F 107 is connected to the network 107-1 and enables transmission and reception of information between the image analyzing device 101 and the external computer, for example. The controller 102 is also capable of obtaining and outputting image information and calculation parameters through the network I/F 107.

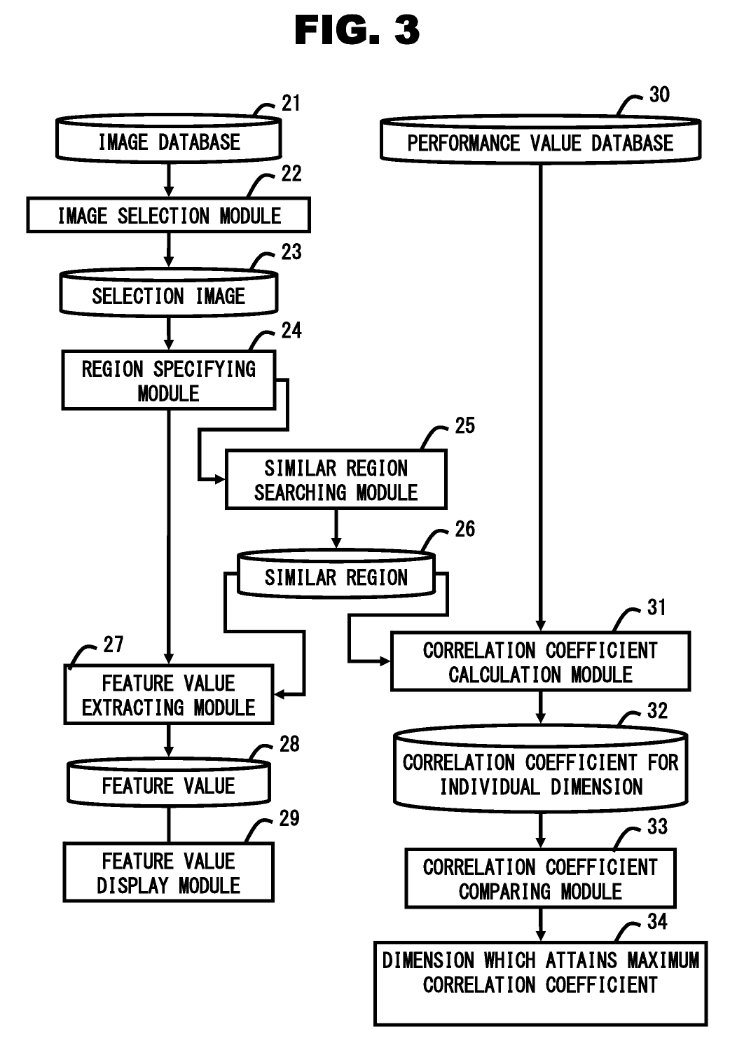

A function of the image analyzing device 101 will now be described. FIG. 3 is a block diagram used to describe the function of the image analyzing device 101.

An image database 21 is a database storing image information items. An image selection module 22 obtains an image information item corresponding to an image selected by the user from an image group. A selection image 23 is an image information item of the image selected by the user from the image group.

A region specifying module 24 obtains information on a selection region (region information item). The selection region is included in an image to be subjected to image analyzing processing and is selected by the user using the input unit 103, for example. In addition to the selection by the user, the selection region may be selected in other ways. For example, a region which is visually different from other images may be automatically extracted in accordance with an association information item. The association information item represents a feature of an object to be displayed as an image. The association information item includes a text information item and a numerical value information item associated with an image information item which correspond to information used to determine whether a product corresponding to the image information item is a nondefective product and information representing a performance value of the product, for example. When the selection region is extracted using the association information item, a computer performs comparison between the images. A similar region searching module 25 searches images other than the image including the selection region for regions similar to the selection region so that the regions similar to the selection region is detected. Similar regions 26 (similar portion) are detected by the similar region searching module 25, are included in the images other than the image including the selection region, and correspond to the selection region of the selected image.

A feature value extracting module 27 calculates feature values of the selection region and the similar regions in the images. Feature values 28 are determined by color, color distribution (coloration), distribution of a contour, pattern, and texture, for example.

A feature value display module 29 controls the output unit 104 to display the calculated feature values in a screen. The feature values are represented by histograms, for example.

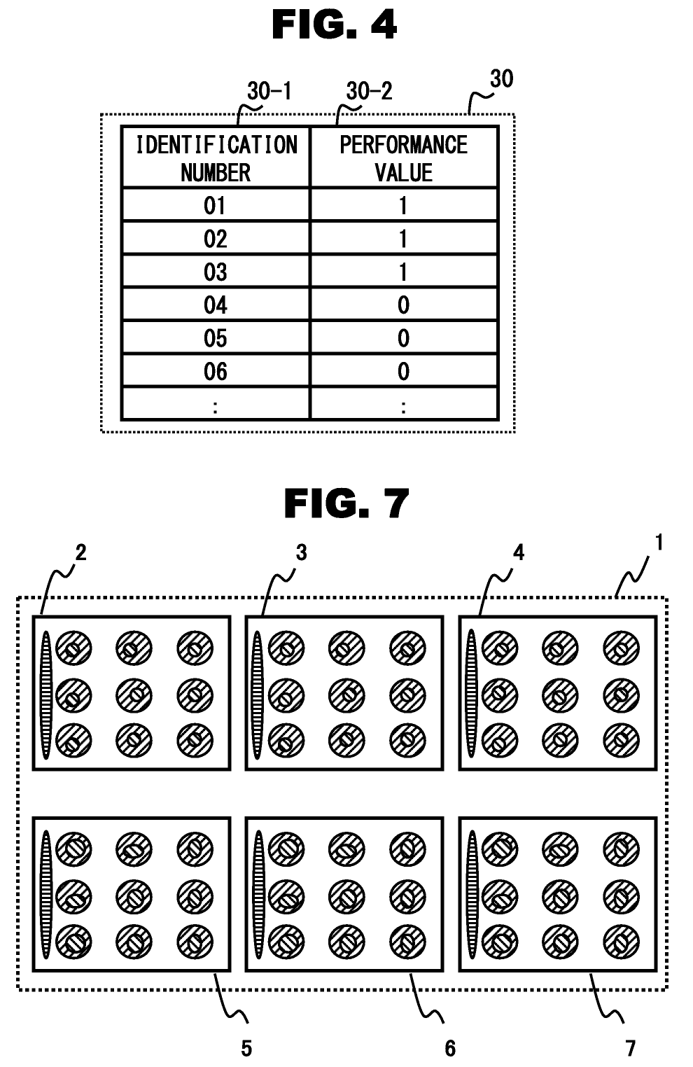

A performance value database 30 stores therein association information items which are associated with image information items. FIG. 4 shows a configuration of the performance value database 30. Identification numbers 30-1 are used to discriminate the images. The identification numbers 30-1 are assigned for individual images. Numerical value information items 30-2 relate to performances of the products. In this embodiment, as the value information items, “1” is assigned to the nondefective products, and “0” is assigned to the defective products. Specifically, in an example shown in FIG. 4, “1” is assigned to identification numbers 01 to 03, and “0” is assigned to identification numbers 04 to 06 as performance values.

The association information items include text information items and numerical value information items which are associated with the image information items. For example, information items used to determine whether products corresponding to the image information items are nondefective products and information items representing performance values of the products are stored in the performance value database 30. A correlation coefficient calculation module 31 calculates coefficients of correlations between the feature values of the selection region 9 and the similar regions in the images and the association information items.

Correlation coefficients 32 for individual dimensions are values representing degrees of the correlations between the feature values and the correlation information items for individual dimensions. A correlation coefficient comparing module 33 detects a dimension 34 which attains a maximum correlation coefficient from among the correlation coefficients 32 for individual dimensions.

By executing the image processing program 108, the controller 102, the input unit 103, the output unit 104, the memory 105, the storage unit 106, and the network I/F 107 function as the image selection module 22, the region specifying module 24, the similar region searching module 25, the feature value extracting module 27, the feature value display module 29, the correlation coefficient calculation module 31, and the correlation coefficient comparing module 33.

The image information items stored in the image database 21 will now be described. FIG. 5 is a diagram illustrating one of the images included in the image group of this embodiment. In FIG. 5, the image 2 included in the image group, which will be described later, is taken as an example. In this embodiment, images are obtained as results of simulations of degrees of stresses generated when printed board and elements of components are attached to each other by soldering. In this embodiment, the stresses correspond to forces per unit area generated when the components are tugged by the printed boards. Shapes of the printed boards are changed due to temperature change in greater degrees than changes of shapes of the components. The stresses are generated when the printed boards are considerably shrunk in the course of returning the heated components and the heated printed boards which are attached to each other by soldering to the components of normal temperatures.

In FIG. 5, a reference numeral 2-1 denotes a component, and a reference numeral 2-2 denotes a region to which a stress is applied as a result of a simulation.

Furthermore, in FIG. 5, a printed board and an element are attached to each other by soldering in junction regions 8-1 to 8-9.

Here, the junction regions 8-1 to 8-9 will be described. FIG. 6 is an enlarged view illustrating one of the junction portions in the image 2. A component 2-1 includes a region 2-3. A reference numeral 2-4 is a junction portion between the component and the printed board. The images of this embodiment represent magnitudes of the stresses applied to the products by three different colors. A table 2-5 illustrates the relationships between the displayed colors and stresses. The table 2-5 shows three colors, i.e., a color 1, a color 2, and a color 3. In this embodiment, the magnitudes of the stresses become large in an order of the color 1, the color 2, and the color 3. The region 2-1 corresponds to the color 1, the region 2-3 corresponds to the color 2, and a region 2-4 corresponds to the color 3. Accordingly, in the component 2-1, the stresses become large in an order of the region 2-3 and region 2-4.

Processes performed using the image analyzing device 101 will now be described in detail. First, a process of displaying the feature values for individual regions of the images in the image group performed using the image analyzing device 101 will be described.

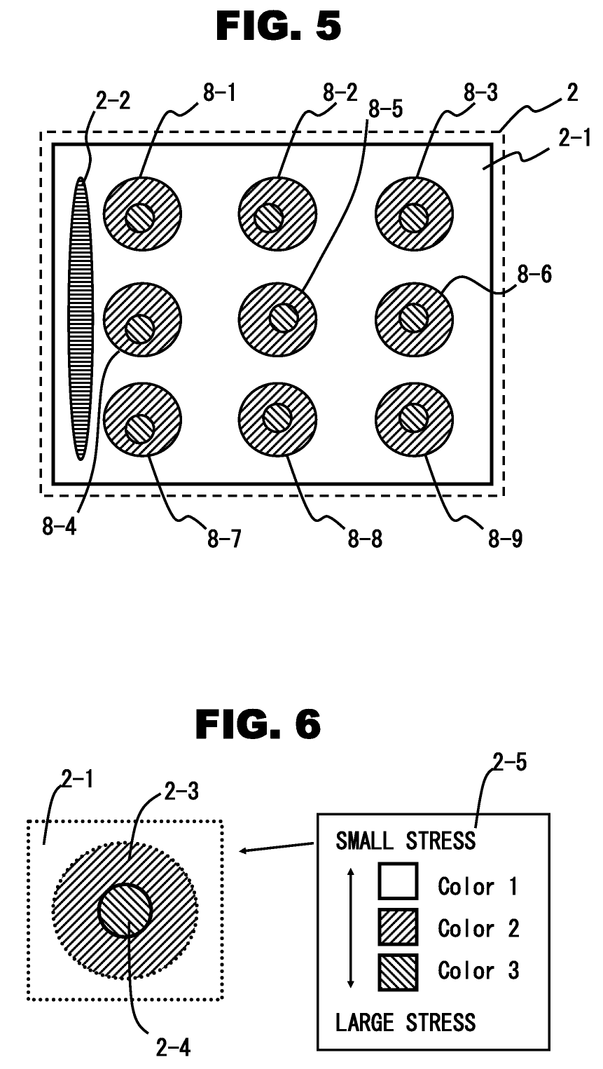

The image analyzing device 101 arranges the images of the image group stored in the image database 21 in a virtual three-dimensional space so as to display the images in a screen. FIG. 7 shows an example of display of the image group 1 arranged in the virtual three-dimensional space. The image group 1 includes the plurality of images 2 to 7. The images 2 to 7 shown in FIG. 7 correspond to the identification numbers 01 to 06, respectively, in the performance value database 30 shown in FIG. 4. Accordingly, the images 2, 3, and 4 are determined to be nondefective products from the performance values 30-2 in the performance value database 30, whereas the images 5, 6, and 7 are determined to be defective products from the performance values 30-2 in the performance value database 30.

The user views the image group 1 displayed in the screen and intends to detect visual features of the images. For example, it is assumed that the user determines that regions of black (color3) surrounded by regions of gray (color2) are small in the images corresponding to the nondefective products whereas the regions of black (color3) surrounded by the regions of gray (color2) are large in the images corresponding to the defective products.

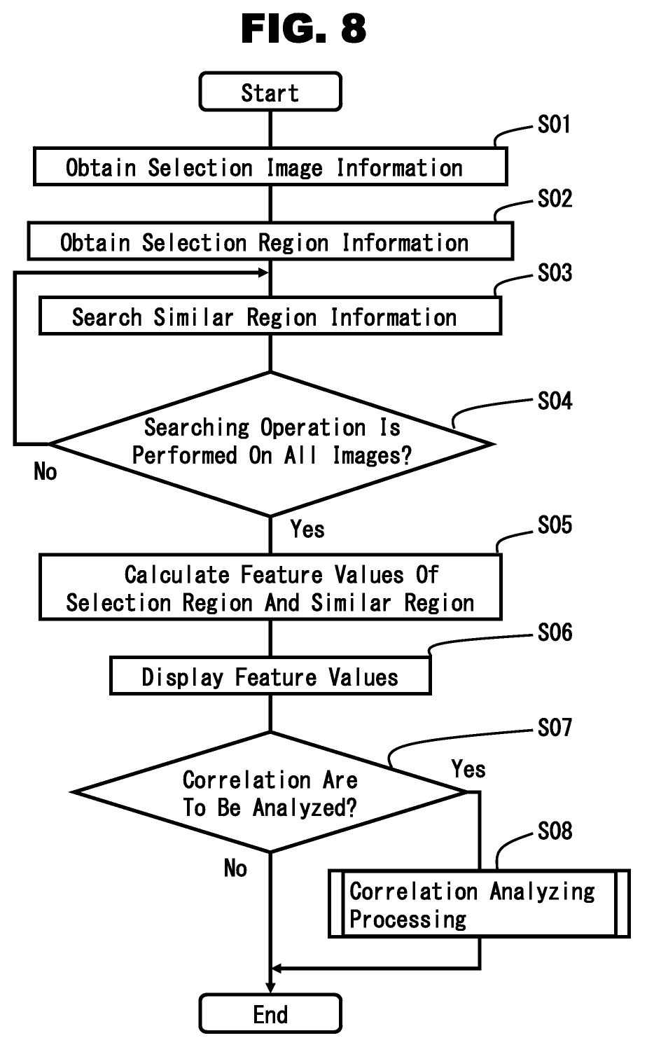

FIG. 8 shows a flowchart illustrating a process of displaying a feature value of a region in an image selected by the user. First, an outline of the process shown in FIG. 8 will be described, and then, steps of the process shown in FIG. 8 will be described in detail. The image analyzing device 101 obtains a selection image information item corresponding to an image selected by the user in step S01, and obtains a selection region information item corresponding to a selection region in the selected image in step S02. Then, the image analyzing device 101 searches for a similar region information item using the obtained selection region information item in step S03. Subsequently, the image analyzing device 101 determines whether the operation of searching for the similar region information item is performed on all the images included in the image group in step S04. When the determination is negative in step S04, the process returns to step S03 where the image analyzing device 101 searches the remaining images for similar region information items. On the other hand, when the determination is affirmative in step S04, the image analyzing device 101 calculates the feature values of the selection region and the similar regions in step S05, and the obtained feature values are displayed in histograms in step S06. In step S07, it is determined whether the correlations between the feature values and the image information items are to be analyzed. When the determination is affirmative in step S07, the image analyzing device 101 performs correlation analyzing processing in step S08. On the other hand, when the determination is negative in step S07, the process is terminated. The steps will be described in detail hereinafter.

The user selects a certain image from among the images included in the image group 1 displayed in the screen by inputting information for specifying the image to be selected through the input unit 103, for example. In this embodiment, it is assumed that the user selects the image 2 from the image group 1. The image selection module 22 obtains a selection image information item corresponding to the image 2 from the image database 21 in step S01.

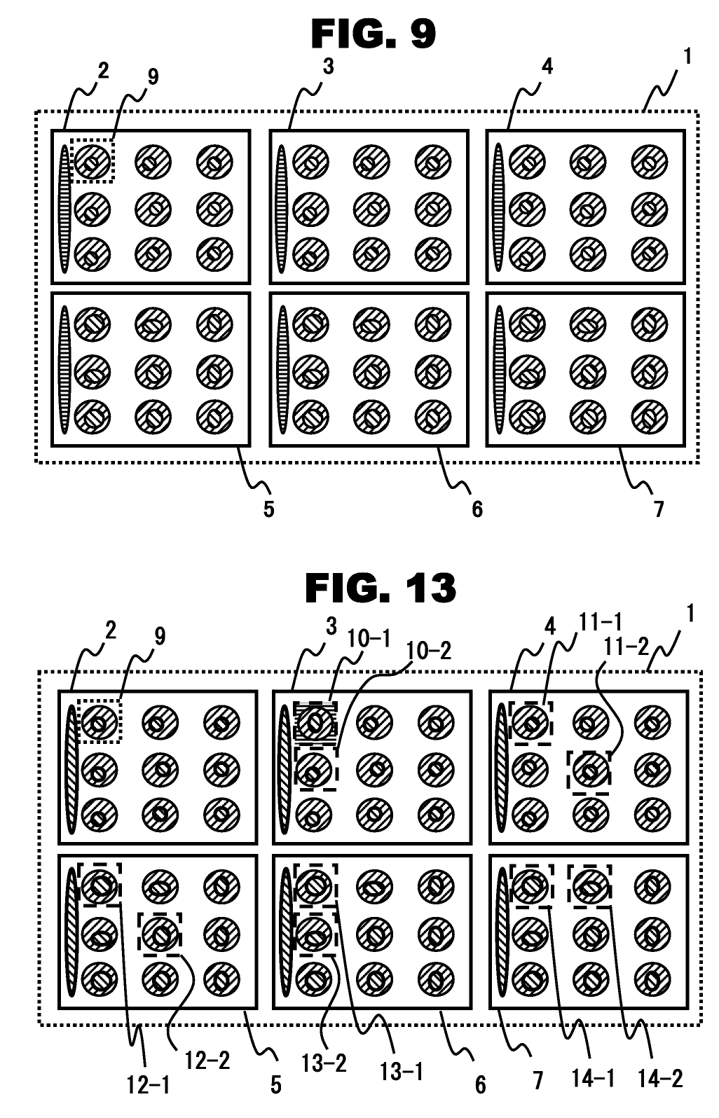

Then, the region specifying module 24 obtains a selection region information item in the selected image 2 in accordance with a user's instruction in step S02. The user selects a certain region in the selected image 2 displayed in the screen using the input unit 103, for example. The user assumes that regions of black (color3) surrounded by regions of gray (color2) are small in the images corresponding to the nondefective products whereas the regions of black (color3) surrounded by the regions of gray (color2) are large in the images corresponding to the defective products while viewing the images displayed in the screen. Note that one of the gray (color2) regions corresponds to the region 2-3 in FIG. 6 and one of the black (color3) regions corresponds to the region 2-4 in FIG. 6. For example, when the user determined the certain region as the selection region, the certain region is surrounded by a rectangle frame. FIG. 9 shows an example of the screen when the certain region in the selected image 2 is selected as the selection region. In FIG. 9, a selection region 9 corresponds to the certain region in the selected image 2 and is defined by the rectangular frame assigned by the user. The image group 1 and the images 2 to 7 are the same as those shown in FIG. 7.

The similar region searching module 25 searches the images for similar regions in step S03. The similar regions are included in the images other than the selected image and correspond to the selection region 9. The images other than selected image 2 in the image group 1 in FIG. 7 are subjected to the searching operation, and therefore, the images 3 to 7 in FIG. 9 are subjected to the searching operation. Images corresponding to the selected image in the image group 1 are referred to as “the other images”.

When the user selects certain regions in the other images, a considerable amount of time is required in proportion to the number of images. Therefore, the similar region searching module 25 performs a semiautomatic operation of specifying the similar regions in the other images. Use of this operation reduces burden of labor for the user required for specifying the similar regions. Furthermore, since positions and sizes are uniformly specified when compared with a case where the similar regions in the other images are manually specified, comparison accuracy is improved.

The operation of searching for the similar regions performed in step S03 using the similar region searching module 25 will now be described in detail hereinafter. An outline of the operation of searching for the similar regions is described below. The similar region searching module 25 detects the images 3 to 7 associated with the selected image 2 from the image group 1. Then, the similar region searching module 25 specifies regions in the images 3 to 7 which are correspond to the selection region 9 in the image 2. Thereafter, the similar region searching module 25 determines the regions specified in the images 3 to 7 to be similar regions and outputs them.

In this embodiment, mainly two criteria are employed for determining “similarity” when the similar region searching module 25 performs the operation of searching for the similar regions. A first criterion is the closeness between a relative position of the selected region relative to the selected image and relative positions of the similar regions relative to the other images. A second criterion is closeness of pixel values in the regions. Priorities assigned to the first and second criteria for the operation of searching for the similar regions are determined in accordance with the image group to be processed and a subject to be processed. Therefore, it is difficult to determine a single weighting function. In this embodiment, the similar regions are appropriately specified in accordance with user's operations.

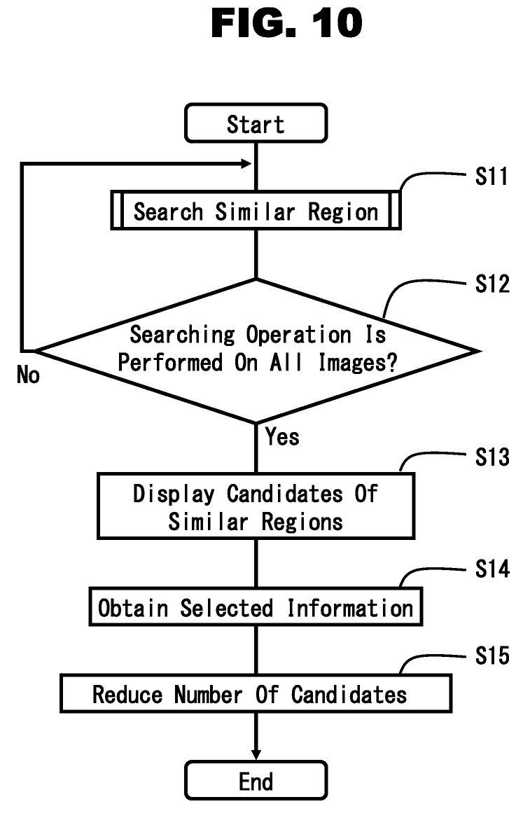

FIG. 10 shows a flowchart illustrating the operation of searching for similar regions. The similar region searching module 25 automatically searches regions in the images 3 to 7 which correspond to the selection region 9 and in the vicinity thereof for similar regions corresponding to the selection region 9 in step S11. Subsequently, it is determined whether all the images in the image group 1 are subjected to the operation of searching for similar images in step S12. When the determination is negative in step S12, the similar region searching module 25 continues to perform the operation of searching for similar regions in the other images. On the other hand, the determination is affirmative in step S12, the similar region searching module 25 displays the regions in the other images which are obtained as results of the searching operation and which are candidates of the similar regions in step S13. The user selects one of the regions of the other images which are candidates of the similar regions in accordance with the display in step S13. The similar region searching module 25 obtains information on the region selected by the user from the image database 21 in step S14. The similar region searching module 25 reduces the number of the candidates of the similar regions in the other images in step S15. The similar region searching module 25 determines a criterion for determining the candidates of the similar regions from the information on the region selected by the user.

Here, an operation of automatically searching regions in the images 3 to 7 which correspond to the selection region 9 and in the vicinity thereof for similar regions corresponding to the selection region 9 performed using the similar region searching module 25 in step S11 will be described in detail. The images 2 to 7 in the image group 1 are obtained as results of simulations. The similar regions include, as described above, regions which have the positional relationships between the regions and the other images the same as the positional relationship between the selection region 9 in image 2. The similar regions further include regions in which distances (degrees of dissimilarity) between the selection region and the regions are small. Therefore, the similar region searching module 25 searches for the candidates of the similar regions on the basis of the two criteria. An example of a method for selecting regions to be candidates of similar regions will be described hereinafter.

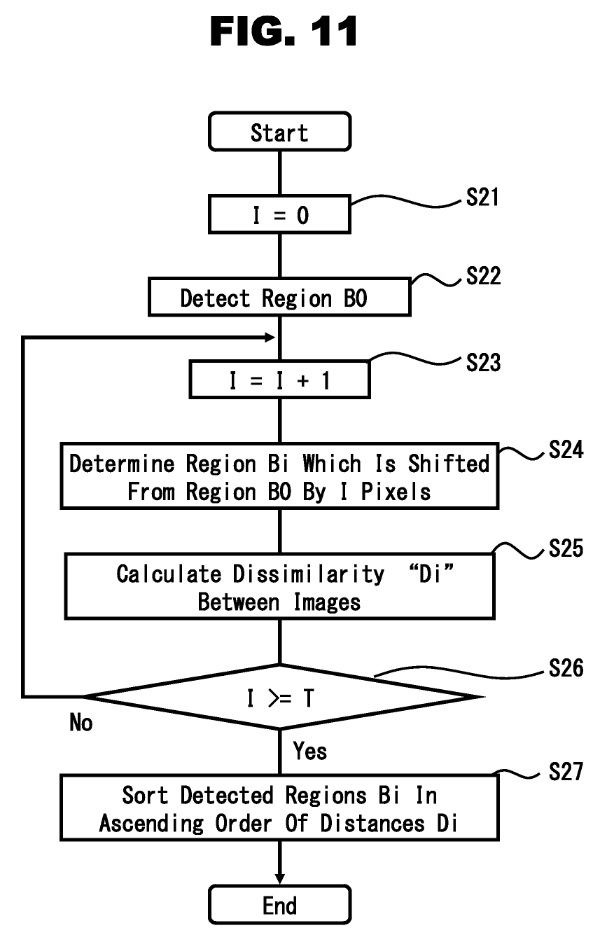

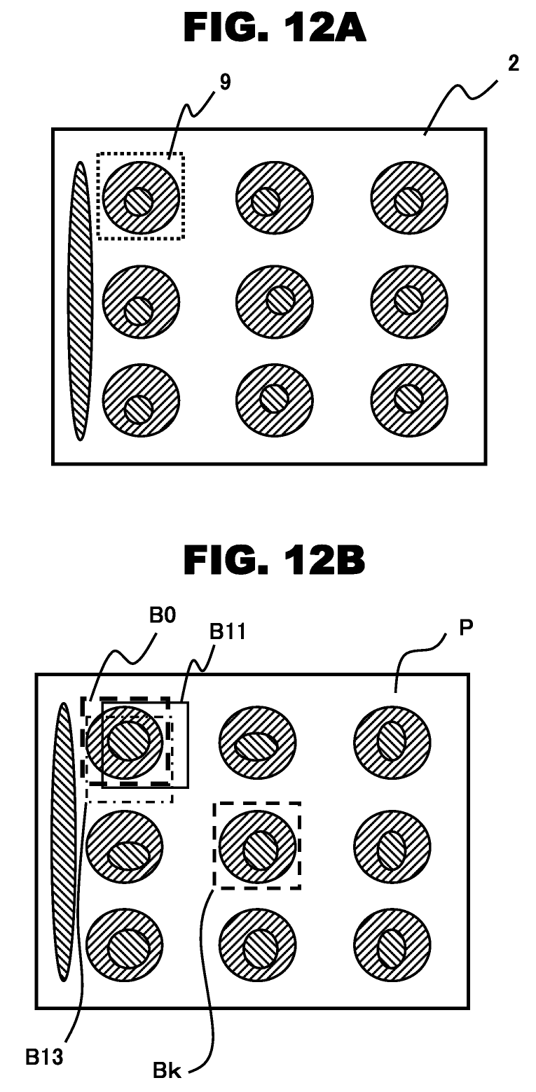

FIG. 11 is a flowchart illustrating an operation of searching for regions to be the candidates of the similar regions. FIGS. 12A and 12B are diagrams used to describe the searching operation. A reference character “B0” denotes a region surrounded by a bold dashed line, a reference character “B11” denotes a region surrounded by a thin solid line, and a reference character “B13” denotes a region surrounded by a thin dashed-dotted line. The similar region searching module 25 initializes a variable “i” in step S21. The variable “i” is used to specify regions in the other images which are to be the candidates of the similar regions when the similar regions are searched for. Specifically, the variable “i” represents the number of pixels which are used to move the regions in the other images.

The similar region searching module 25 detects the region B0 in an image P selected from among the other images in step S22. A position of the region B0 in the image P relatively corresponds to a position of the selection region 9 in the image 2. The position of the selection region 9 is obtained as a position in a coordinate of the image 2 and a range of the selection region 9 is also obtained using the coordinate. Accordingly, the region B0 which is located in a coordinate position in the image P corresponding to the coordinate position of the selection region 9 in the image 2 and which has a size the same as that of the selection region 9 can be determined. Here, since the variable “i” is “0”, the region B0 located in the position corresponding to the coordinate position of the selection region 9 is determined.

Then, from step S23 to step S26, regions located in positions shifted by small distances (degrees of dissimilarity) from the similar region B0 corresponding to the selection region 9 are searched for. The similar region searching module 25 increments the variable “i” by one in step S23. The similar region searching module 25 determines a region Bi which is shifted from the region B0 by i pixels in step S24. For example, the region B11 is obtained by shifting the region B0 rightward by one pixel, and the region B13 is obtained by shifting the region B0 downward by one pixel. Therefore, the regions B11 and B13 shown in FIG. 12B are located in positions shifted from the region B0 by one pixel.

Note that regions shifted from the region B0 by two pixels are regions. Specifically, a region is obtained by shifting the region B0 rightward by two pixels, a region is obtained by shifting the region B0 upward by two pixels, a region is obtained by shifting the region B0 leftward by two pixels, a region is obtained by shifting the region B0 downward by two pixels, a region is obtained by shifting the region B0 rightward by one pixel and upward by one pixel, a region is obtained by shifting the region B0 upward by one pixel and leftward by one pixel, a region is obtained by shifting the region B0 leftward by one pixel and downward by one pixel, and a region is obtained by shifting the region B0 downward by one pixel and rightward by one pixel. Here, the region, obtained by shifting the region B0 rightward by one pixel and upward by one pixel, is obtained by shifting the region B0 rightward by one pixel and then upward by one pixel, or by shifting the region B0 upward by one pixel and then rightward by one pixel. Although identical regions may be thus obtained by different shifting ways, regions to be specified should not be overlapped.

Then, the similar region searching module 25 calculates distances (degrees of dissimilarity) between images in step S25. Specifically, a distance (degrees of dissimilarity) between an image in the selection region 9 and images in the region Bi specified in the image P is obtained. The distances (degrees of dissimilarity) between the images are values used to evaluate displacement between the selection region 9 and the regions to be the candidates of the similar regions, and are obtained for selecting one of the regions to be the candidates of the similar regions. The distances (degrees of dissimilarity) between images are obtained as follows, for example.

It is assumed that n pixels are included in the selection region 9 and n pixels are included in a region Bi to be a candidate of one of the similar regions. The pixels have unique values. Assuming that the pixels included in the selection region 9 are denoted by sn, and the pixels in the region to be the candidate of one of the similar regions are denoted by rn, the selection region 9 is represented by S(s1 to sn) and the region to be the candidate of one of the similar regions is represented by R(r1 to rn). Then, differences between the unique values of the pixels included in the selection region 9 and the unique values of the pixels which are included in the region to be the candidate of one of the similar region and which are positioned so as to correspond to the pixels in the selection region 9 are obtained. The differences between the unique values are obtained for individual corresponding pairs of a pixel and a corresponding pixel, the obtained differences are each multiplied, the multiplied differences obtained for individual pairs of a pixel and a corresponding pixel are added to one another so that a total sum di of all the pixels in the regions is obtained. The total sum di corresponds to a distance Di between the image of the selection region 9 and the image in the region to be the candidate of one of the similar regions. Note that not only the total sum but also distances between vectors of image features (vector format) such as color histograms in the respective regions may be employed as the distances between the images.

The similar region searching module 25 determines whether the variable “i” is larger than a constant “T” in step S26. The constant “T” is a value used to determine a range in which the operation of searching for the regions to be the candidates of the similar regions is performed. The constant “T” is appropriately determined in accordance with a feature of the image group 1. For example, information on a range in which displacement among the products corresponding to the images is considered to be generated is obtained in advance, and the constant “T” is determined in accordance with the information. The number of pixels to be moved in order to specify a region may be determined in accordance with a degree of the displacement.

When the determination is negative in step S26, the process in step S23 onwards is repeatedly performed. On the other hand the determination is affirmative in step S26, the similar region searching module 25 sorts the detected regions Bi in an ascending order of distances Di of the images of the regions Bi to be the candidates of the similar regions in step S27. Note that the number of the candidates of the similar regions to be obtained is determined as “k”. After the regions Bi are sorted in the ascending order of the distances Di of the images, k regions Bi are selected from among the regions Bi in the ascending order of the distances Di as the candidates of the similar regions. In this way, the candidates of the similar regions are obtained.

Furthermore, as another method for specifying regions in step S11, a certain area having a predetermined size is determined which includes the region B0 as a center, and the region B0, and regions B10, B11, B12, B13 and so on may be set in the certain area.

FIG. 12B shows two candidates of the similar regions included in the image P which correspond to the selection region 9. The candidates of the similar regions are regions B0 and Bk. A position of the region B0 relative to the image P is determined to be the most similar to a position of the selection region 9 relative to the selected image 2. On the other hand, the region Bk is selected in accordance with a degree of similarity to the selection region 9. Alternatively, discrimination whether the positional relationship between the selection region 9 and the image 2 is the same as the positional relationship between the candidates of the similar regions and the other corresponding images or distances Di between the image in the selection region 9 and the images in the similar regions are small may be displayed. For example, as a method for displaying the discrimination, frame lines or colors of the regions may be changed, or the frame lines or the regions may be blinked.

The similar region searching module 25 terminates the operation of searching for the similar regions after all the images relating to the selected image 9 in the image group 1 have subjected to the searching operation. When the similar region searching operation performed on all the images in the image group 1 is terminated, the regions in the other images which are the candidates of the similar regions obtained as results of the searching operation are displayed in step S13. FIG. 13 is an example of the screen which displays the candidates of the similar regions. In FIG. 13, the candidates of the similar regions corresponding to the selection region 9 in FIG. 9 are displayed. The images 3 to 7 correspond to the image R Regions 10-1, 11-1, 12-1, 13-1, and 14-1 correspond to the region B0 in the image P in FIG. 12B. Regions 10-2, 11-2, 12-2, 13-2, and 14-2 correspond to the region Bk in the image P in FIG. 12B.

The similar region searching module 25 obtains image information items of regions to be selected included in the images 3 to 7 from the image database 21 in step S14. The user selects one of the similar regions displayed in the screen using the mouse, for example. The similar region searching module 25 obtains an image information item of the candidate of the similar region selected by the user from the image database 21. The similar region searching module 25 performs an operation of reducing the number of the candidates of the similar regions using the selected candidate of the similar region in step S15. It is assumed that the region in the image 3 is selected in step S14, the similar region searching module 25 performs the operation of reducing the number of the similar regions on the remaining images 4 to 7. A criterion for selecting the similar regions is described below. For example, when a position of one of the candidates of the similar region which is selected by the user in an image information item thereof corresponds to the position of the selection region 9 in the image 2, the similar region searching module 25 detects, from among the candidates of the similar regions in the remaining images, candidates in which the positional relationships between the candidates and the corresponding images are similar to the positional relationship between the selection region 9 and the image 2 as the similar regions. On the other hand, when the candidate of the similar region selected by the user has pixel values similar to pixel values of the image in the selection region 9, the similar region searching module 25 detects, from among the candidates of the similar regions in the remaining images, candidates which have pixel values of high degrees of similarities to the pixel values of the image in the selection region 9 as the similar regions.

In FIG. 13, it is assumed that the user selects the region 10-1 in the image 3 as the similar region. The similar region searching module 25 changes a display color of the selected region 10-1, for example. In this embodiment, when the user selects one of the regions in the other images which relatively similar to the selection region in the selected image, similar regions are detected in the remaining other images on the basis of the positions of the regions in the images. A position of the region 10-1 relative to the image 3 is similar to a position of the selection region 9 relative to the image 2 more than a position of the region 10-2 relative to the image 3. Therefore, the similar region searching module 25 detects, from among the candidates of the similar regions in the remaining mages 4 to 7, regions which have the positional relationships relative to the corresponding images similar to the positional relationship between the selection region 9 and the image 2 as the similar regions. In FIG. 13, regions to be detected as the similar regions are regions 11-1, 12-1, 13-1, and 14-1.

On the other hand, it is assumed that the user selects the region 10-2 in the image 3 as a similar region. The similar region searching module 25 changes a display color of the selected region 10-2, for example. A position of the region 10-2 relative to the image 3 is not the most similar to a position of the selection region 9 relative to the image 2. Therefore, the similar region searching module 25 detects, from among the candidates of the similar regions in the mages 4 to 7, regions which have pixel values of high degrees of similarities to the pixel values of the image in the selection region 9 as the similar regions. In FIG. 13, regions to be detected as the similar regions are regions 11-2, 12-2, 13-2, and 14-2.

Note that the user may manually selects the similar regions in the images as needed. Furthermore, the user may newly specify a region other than the candidates of the similar regions.

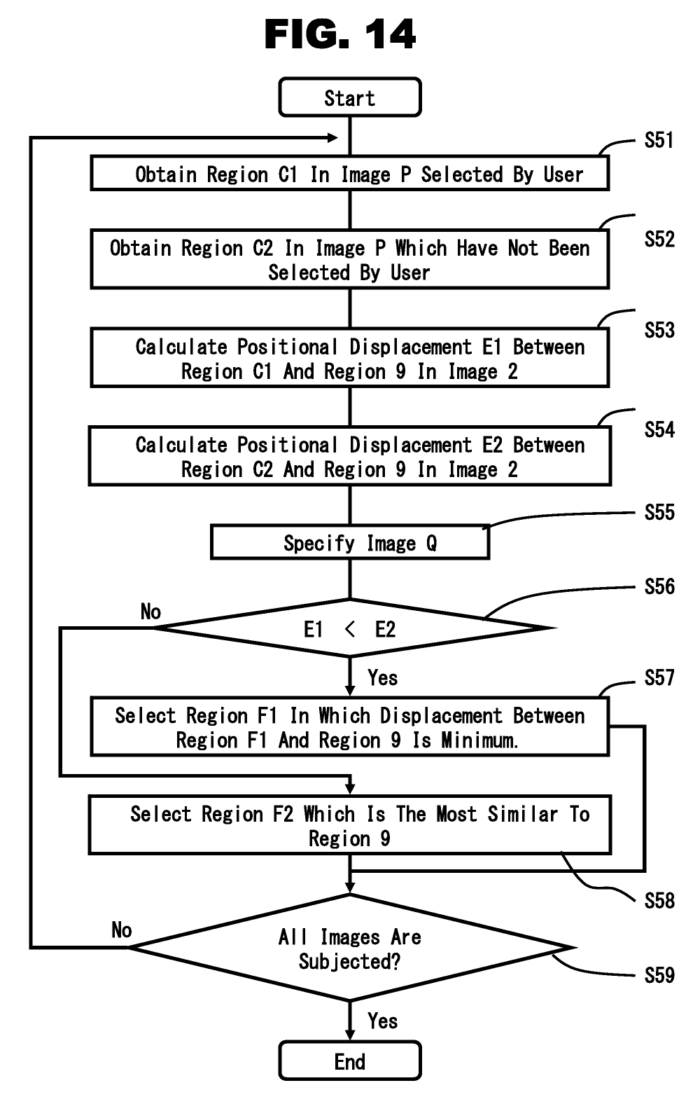

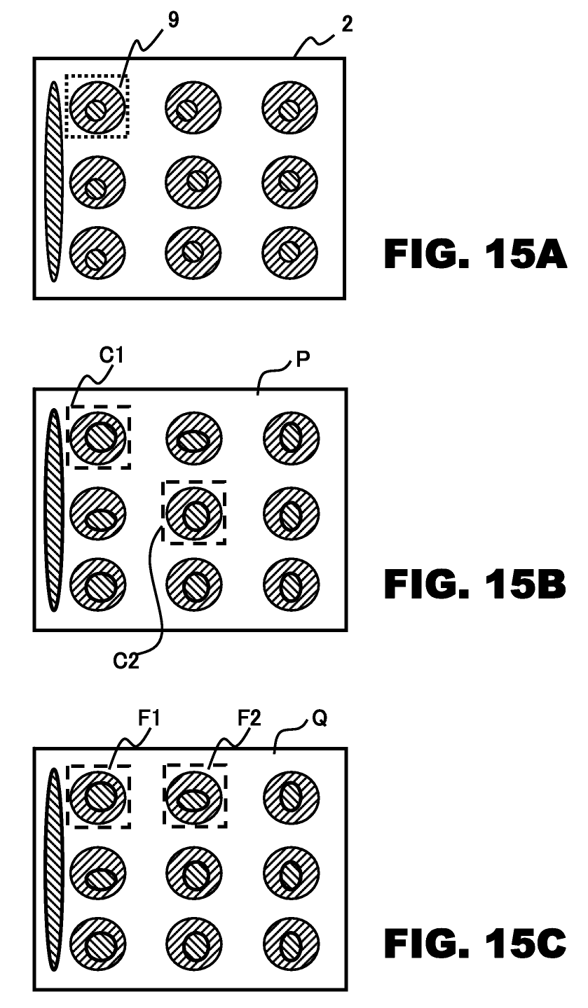

The operation of reducing the number of the candidates performed in step S15 will be described in detail hereinafter. FIG. 14 shows a flowchart illustrating the operation of reducing the number of the candidates of the similar regions. FIG. 15A, FIG. 15B, and FIG. 15C show a diagram used to describe the operation of reducing the number of the candidates of the similar regions. In FIG. 15A, a reference numeral 2 denotes a selected image, and a reference numeral 9 denotes a selection region. In FIG. 15B, the candidates of the similar regions are selected or to be selected from images P and Q by the user. In the image P, regions C1 and C2 are detected as the candidates of the similar regions. A position of the region C1 relative to the image P corresponds to a position of the selection region 9 relative to the image 2 of FIG. 15A. The region C2 is a region to be the candidate of the similar region in the image P and a distance Di between an image in the region C2 and an image in the selection region 9 is minimum among distances Di between images in regions to be the candidates of the similar regions in the image P and the image in the selection region 9 of FIG. 15A. That is, the region C2 has pixel values similar to the pixel values in the selection region 9 of FIG. 15A. Note that, in an example below, it is assumed that the user inputs information so that the region C1 is selected to be the candidate of the similar region.

In FIG. 15C, as with the regions C1 and C2 of FIG. 15B, regions F1 and F2 in the image Q are detected as the candidates of the similar regions. A position of the region F1 relative to the image Q corresponds to a position of the selection region 9 relative to the image 2 of FIG. 15A. The region F2 is a region to be the candidate of the similar region in the image Q and a distance Di between an image in the region F2 and an image in the selection region 9 is minimum among distances Di between images in regions to be the candidates of the similar regions in the image Q and the image in the selection region 9 of FIG. 15A. That is, the region F2 has pixel values similar to the pixel values in the selection region 9.

Hereinafter, processes executed using the similar region searching module 25 will be described. The similar region searching module 25 obtains a region information item corresponding to a region in the image P selected by the user in step S51. Here, it is assumed that the region C1 in the image P is selected by the user. Subsequently, the similar region searching module 25 obtains a region information item corresponding to one of regions in the image P which have not been selected by the user in step S52. Here, it is assumed that the region C2 in the image P is determined to be one of the regions in the image P which have not been selected by the user and selected by the similar region searching module 25.

Then, the similar region searching module 25 calculates a positional displacement E1 between a relative position of the region C1 in the image P and a relative position of the selection region 9 in the image 2 in step S53. For example, the similar region searching module 25 compares coordinate position information of the region C1 relative to the image P with coordinate position information of the selection region 9 relative to the selected image 2. Subsequently, the similar region searching module 25 calculates a positional displacement E2 between a relative position of the region C2, which is selected by the similar region searching module 25, in the image P and the relative position of the selection region 9 in the image 2 in step S54. For example, the similar region searching module 25 compares coordinate position information of the region C2 relative to the image P with the coordinate position information of the selection region 9 relative to the selected image 2. Then, the similar region searching module 25 specifies the image Q in step S55.

The similar region searching module 25 compares the displacement E1 between the relative position of the selection region 9 in the selected image 2 and the relative position of the region C1 in the image P with the displacement E2 between the relative position of the selection region 9 in the selected image 2 and the relative position of the region C2 in the image P in step S56. When it is determined that the displacement E1 is smaller than the displacement E2 in step S56, that is, the determination is affirmative in step S56, the relative position of the region C1 associated with the displacement E1 in the image P is determined to be similar to the relative position of the selection region 9 in the selected image 2. On the other hand, when the displacement E1 is not smaller than the displacement E2 in step S56, that is, the determination is negative in step S56, the region C2 associated with the displacement E2 is determined to have a high degree of similarity to the selection region 9. When the determination is affirmative in step S56, the similar region searching module 25 selects a region F1 in which a displacement between a relative position of the region F1 in the image Q and the relative position of the selection region 9 in the selected image 2 is minimum from the image Q in step S57.

On the other hand, when the determination is negative in step S56, the similar region searching module 25 selects a region F2 including an image which is the most similar to the image in the selection region 9 from the image Q in step S58. Then, the similar region searching module 25 determines whether all the images included in the image group 1 are subjected to the above-described processing in step S59. When the determination is negative in step S59, one of the remaining images is set and the process from step S51 onward are performed on the one of the remaining images. On the other hand, when the determination is affirmative in step S59, the process of FIG. 14 is terminated. Note that after all the images are processed, the number of the similar regions is reduced in the images other than the selected image 2 in the image group 1.

FIG. 16 is an example of a screen displaying results of detection of the similar regions. In FIG. 16, it is assumed that the user specifies the region 10-1 in the image 3 as the similar region. Note that the region 12-2 in the image 5 is selected by the user as the similar region.

As described above, the similar region searching module 25 reduces the number of the candidates of the similar regions so as to determine the similar regions. Thereafter, the feature value extracting module 27 obtains feature values of the selection region 9 and the similar regions. The feature value display module 29 displays histograms on the basis of the obtained feature values.

Note that the region B0 is arranged in the image P so as to relatively correspond to a position of the selection region 9 in the selected image 2, and also may have pixel values the most similar to the pixel values of the selection region 9 in the image R In this case, for example, the region B0 may be displayed in the screen by changing a color of a frame surrounding the region B0. For example, a candidate of a similar region corresponding to a relative position of the selection region 9 in the selected image 2 is displayed by being surrounded by a frame of a first color, and a candidate of a similar region which is the most similar to the selection region 9 is displayed by being surrounded by a frame of a second color. A candidate of a similar region which is arranged so as to correspond to a relative position of the selection region 9 in the selected image 2 and which is most similar to the selection region 9 is displayed by a frame of a third color. When the user selects the frame of the third color, the similar region searching module 25 displays a question to the user which criterion is used for the operation of reducing the number of the candidates of the similar regions in the remaining images. The similar region searching module 25 allows the user to determine whether matching of relative positions between regions are employed as the criterion or similarities of the regions are employed as the criterion, for example. In accordance with information on the user's determination, the similar region searching module 25 performs the operation of reducing the number of the similar regions in the remaining images.

Next, an operation of calculating feature values in the regions performed in step S06 in FIG. 8 will be described. The feature value extracting module 27 automatically extracts image feature values as color histograms from images in the selection region 9 and the similar regions. The color histograms are obtained by examining pixel values (colors) in pixels included in the selection region 9 and the similar regions and counting the numbers of pixels for individual colors. In general, the extracted feature values are represented by multidimensional vectors. In the color histograms, the extracted feature values include numerical value information items regarding the numbers of pixels for individual colors. Instead of the color histograms, shape feature values of the images may be used as the image feature values. Instead of a method utilizing a predetermined single method for extracting image feature values, a plurality of methods for extracting image feature values which are supposed to be utilized may be set in advance and the plurality of methods for extracting image feature values may be changed from one to another in accordance with a user's instruction. Examples of the plurality of methods for extracting image feature values include the “color histograms” and the “shape feature values”. In this embodiment, it is assumed that the user inputs selection information which specifies the “color histograms” as the image feature values.

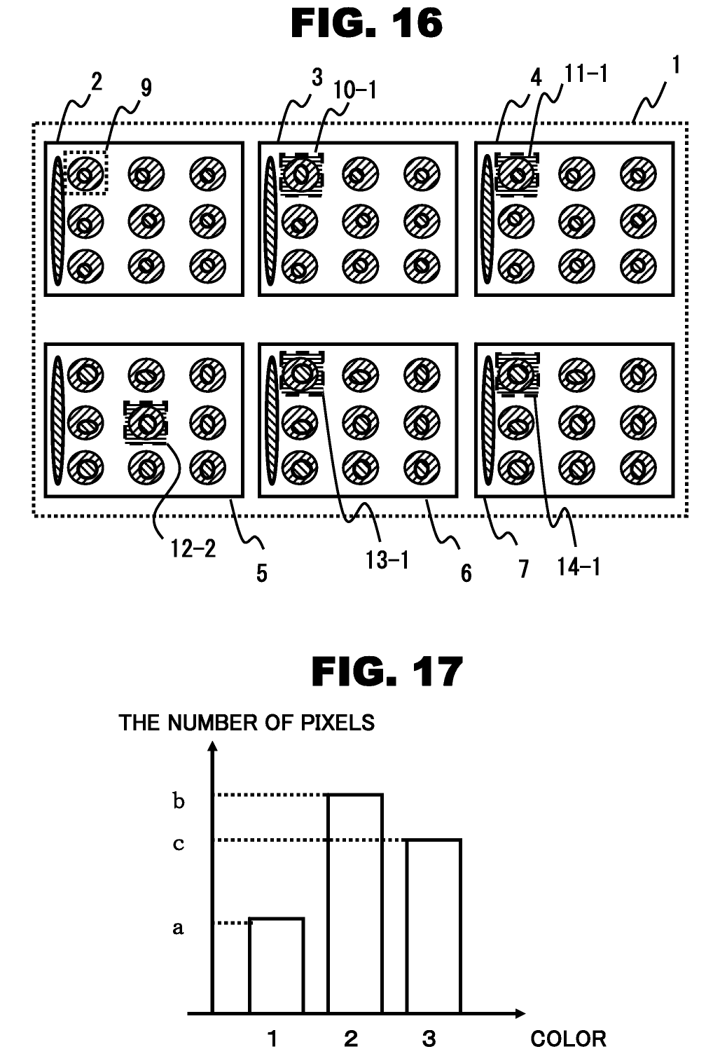

The feature value display module 29 displays the feature values corresponding to the selection region 9 and the similar regions in the image information items. For example, when the color histograms are used for the feature values, the feature value display module 29 displays color histograms for the selection region 9 and the similar regions in the images. FIG. 17 is a configuration example of a representative color histogram. In this color histogram, an axis of abscissa denotes a color and an axis of ordinate denotes the number of pixels in a region. In this embodiment, a color 1, a color 2, and a color 3 are employed as colors. In FIG. 17, the number of pixels of the color 1 is “a”, the number of pixels of the color 2 is “b”, and the number of pixels of the color 3 is “c”.

FIG. 1 shows an example of a screen which displays the feature values of the regions in the image information items. The feature value display module 29 displays the color histograms 9-2, 10-3, 11-3, 12-3, 13-3, and 14-3 of the selection region 9 in the image 2 and the similar regions 10-1, 11-1, 12-2, 13-1, and 14-1, respectively. When comparing the image information items with one another, the image analyzing device 101 displays features of regions in images selected from among the images as histograms. Since the feature values are displayed as the histograms, features such as colors of the images in the regions are compared with one another by numerical values. Accordingly, the user can quantitatively describe the following assumption: “a nondefective product has an area of the color 3 in an area of the color 2 of 10, and a defective product has an area of the color 3 in an area of the color 2 of 20”. As described above, when detection of knowledge from the image group is assisted, the relationship between a feature of a region in an image found by the user and performance information can be quantitatively defined. The term “knowledge” is information derived from the relationship between “a visual feature of an image” and “content of feature data” obtained from a pair of image and feature data (a numerical value and text) regarding the image.

Next, an operation of calculating correlation coefficients among the regions in the images will be described. The feature values of the images corresponding to the regions can be represented by numerical values by performing the processes up to step S06 in FIG. 8. By performing the operation of calculating the correlation coefficients, degrees of correlations between differences among visual feature values of the images and association information items regarding the images can be detected.

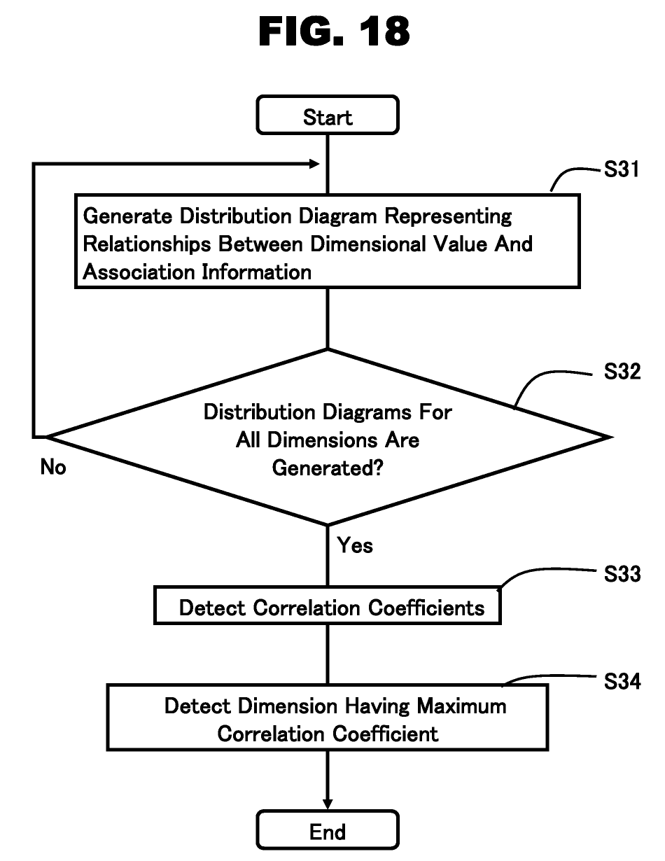

The image analyzing device 101 determines whether analysis of the correlations between the image feature values and the association information items is performed in step S07. When the determination is affirmative in step S07, correlation analyzing processing is performed in step S08. The correlation coefficient calculation module 31 performs processing below. FIG. 18 shows a flowchart illustrating an operation of calculating the correlation coefficients.

The feature values calculated using the feature value display module 29 are represented by multidimensional vectors. Dimensions of the multidimensional vectors correspond to colors. Therefore, the correlation coefficient calculation module 31 generates distribution diagrams representing the relationships between dimensional values and the association information items for individual dimensions of the multidimensional vectors in step S31. The association information items are values representing performances of the products, for example. As the values representing performances of the products, “1” is assigned to nondefective products, and “0” is assigned to defective products. It is assumed that, in this embodiment, as absolute values of the correlation coefficients are close to “1”, the relationships between the visual features of the images and the performance values are strong, whereas as the absolute values of the correlation coefficients are close to “0”, the relationships are weak. Therefore, when the image feature values change as the performance values increase, the correlation between the performance values and the image feature values are strong, that is, high correlations are attained.

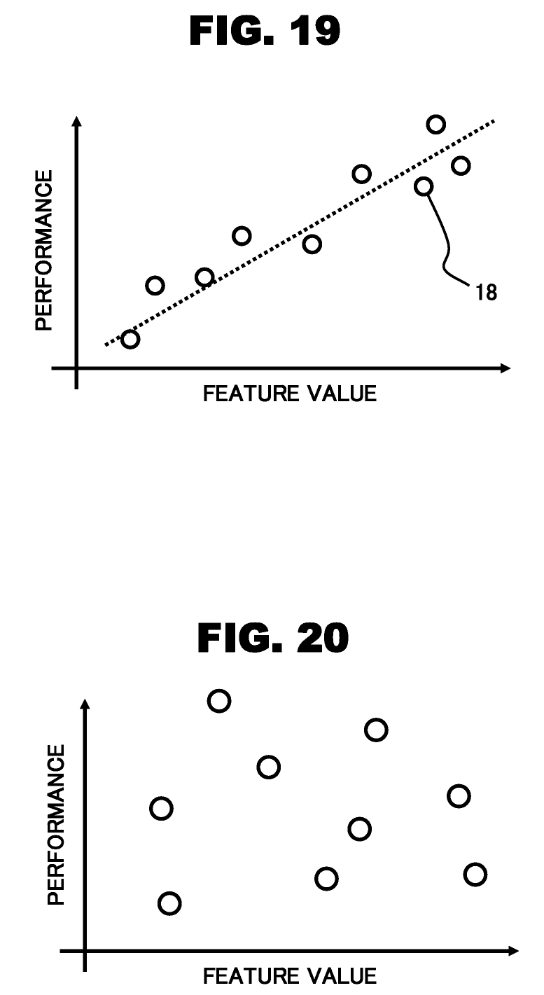

FIGS. 19 and 20 are distribution diagrams illustrating the relationships between the performance values and the feature values. In the distribution diagrams, axes of ordinate denote a performance value and axes of abscissa denote an image feature value. Note that the performance values shown in FIGS. 19 and 20 are values other than “0” and “1”. A point 18 is an intersection of an image feature value in a specific dimension obtained for each image region and a performance value. FIG. 19 is the distribution diagram in a case where a correlation coefficient is close to “1”. FIG. 20 is the distribution diagram in a case where a correlation coefficient is close to “0”.

In step S32, the correlation coefficient calculation module 31 determines whether distribution diagrams for all the dimension of the multidimensional vectors are generated. When the determination is negative in step S32, the correlation coefficient calculation module 31 further performs the operation of generating a distribution diagram illustrating the relationship between a performance value and a feature value. On the other hand, when the determination is affirmative in step S32, the correlation coefficient calculation module 31 detects correlation coefficients from the distribution diagrams of the different dimensions in step S33. The correlation coefficient calculation module 31 performs the following calculation represented by Equation 1 so as to calculate the correlation coefficients for individual dimensions.

$$r = \frac{{\sum }_{i = 1}^{n} ( {x}_{i} - {x}_{a} ) ( {y}_{i} - {y}_{a} )}{\sqrt{{\sum }_{i = 1}^{n} {( {x}_{i} - {x}_{a} )}^{2} {\sum }_{i = 1}^{n} {( {y}_{i} - {y}_{a} )}^{2}}} \qquad ( Equation 1 )$$

In Expression 1, “r” denotes a correlation coefficient and is not less than “−1” and not larger than “1”, “n” denotes the number of samples of images, “xi” denotes an image feature value of an i-th sample, “yi” denotes a performance value of the i-th sample, “xa” denotes an average value of image feature values of all samples, and “ya” denotes an average value of performance values of all the samples.

The correlation coefficient comparing module 33 detects a dimension having the maximum correlation coefficient from among the correlation coefficients for individual dimensions (colors) of the multidimensional vectors in step S34. The correlation coefficient comparing module 33 is capable of obtaining a dimension (color) having the maximum correlation coefficient for a performance value (a nondefective produce or a defective product).

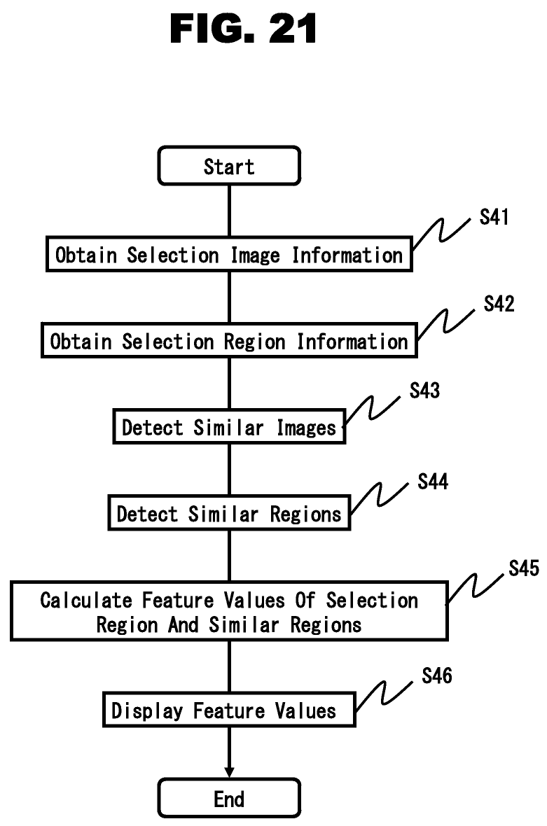

Here, a case where the user selects a region from among the selection region 9 and the similar regions in which a feature value thereof is to be displayed will be described. FIG. 21 shows a flowchart illustrating an operation of displaying a feature value in a region in an image selected by the user. The image analyzing device 101 arranges and displays the image group 1 in the image database 21 in a virtual three-dimensional space in a screen. Description will be made with reference to the example of the screen shown in FIG. 7. The user views the image group 1 displayed in the screen and intends to detect visual features of the images. For example, it is assumed that the user determines that regions of black (color 3) surrounded by regions of gray (color 2) are small in the images corresponding to the nondefective products whereas the regions of black (color 3) surrounded by the regions of gray (color 2) are large in the images corresponding to the defective products.

The user selects a certain image from the image group 1 displayed in the screen. The user selects the certain image by inputting information used to specify the image to be selected through the input unit 103, for example. In this embodiment, the user selects the image 2 from the image group 1. The image 2 is referred to as a selected image hereinafter. The image selection module 22 obtains a selection image information item corresponding to the selected image 2 from the image database 21 in step S41. Then, the region specifying module 24 obtains a selection region information item of a region selected from the selected image 2 in step S42. The user determines that the region 2-4 surrounded by the region 2-3 is small in the images corresponding to the nondefective products whereas the region 2-4 surrounded by the region 2-3 is large in the images corresponding to the defective products (refer to FIG. 6). The user selects the region (hereinafter referred to as the “selection region”) from the selected image 2 displayed in the screen through the input unit 103. For example, the user marks the selection region by surrounding the selection region in the selected image 2 by a rectangular frame. FIG. 9 shows the example of the screen when the selection region in the selected image is selected. A reference numeral 9 denotes the selection region. The selection region 9 is the certain region in the selected image 2 surrounded by the rectangular frame. The image group 1 and the images 2 to 7 are the same as those shown in FIG. 5. The user selects similar images and images of interest as similar regions from the image group 1 displayed in the screen in step S43 and step S44. These selections are realized by processes similar to the processes performed in step S41 and step S42. Then, the feature value extracting module 27 calculates feature values of the selection region 9 and the similar regions in step S45. The feature value display module 29 displays the feature values of the selection region 9 and the similar regions in the screen in step S46.

Here, another example of the processing of calculating the region B0 performed in step S22 will be described. The images in the image group 1 are preferably images which are easy to compare with one another. However, even if the images are obtained as results of simulations, pixels of the images may be displaced. Furthermore, even if the images are obtained under the identical photographing condition, differences between positions of a camera relative to the products or differences between inclinations of the camera relative to the products may be generated. Therefore, portions of the products corresponding to specific pixels in the corresponding images are not necessarily located in the same position in the image group 1. Accordingly, positions of the images relative to the corresponding other images may be displaced from a coordinate of the selection region 9 relative to the selected image 2. Therefore, the similar region searching module 25 may search regions in the vicinity of the regions in other images which are located so as to relatively correspond to a coordinate position of the selection region 9 and which include objects the most similar to an object of interest included in the selection region 9 for the similar regions. For example, the similar region searching module 25 moves the regions by several peripheral pixels and detects whether a region to be a candidate of a similar region which has the smallest distance to the image in the selection region 9 is exist. When the determination is affirmative, the similar region searching module 25 set the region having the smallest distance as the region B0. Note that a value of the range of the several peripheral pixels is smaller than the constant “T” which is a value used to determine a range in which the operation of searching for the regions to be the candidates of the similar regions is performed.

The image processing described above is applicable to a field of image mining which assists finding of knowledge from an image group including many images. In this embodiment, images in a manufacturing field are taken as examples. The image processing of this embodiment may be applicable to a wide range of fields, such as searching, analyzing, and mining for multimedia information (images, video images, drawings, three-dimensional CAD (Computer Aided Design) data, volume data), knowledge management, PLM (Product Lifecycle Management), CAE (Computer Aided Engineering), designing, manufacturing, marketing, and medical care.

Note that as another embodiment, an operation of specifying regions in the images which are possible to be associated with the performance values using differences of the performance values may be performed. For example, the image analyzing device 101 obtains correlations between a performance value included therein in advance and color distributions of the regions in the images for individual images of the products. The image analyzing device 101 searches the images for regions having correlation coefficients close to 1 or −1. The image analyzing device 101 specifies regions in the images which have the correlation coefficients relative to the performance values close to 1 or −1.

Furthermore, as an application of this embodiment, when the correlations between the images and the performance values are obtained, performances of the other images can be predicted in accordance with the obtained correlations. For example, it is assumed that the image analyzing device 101 obtains the correlation coefficients between image features and the performance values in advance. Thereafter, when obtaining image information items, the image analyzing device 101 predicts the performance values from the image information items and the correlation coefficients. Accordingly, the user can predict performances of the products.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording

media. The program/software implementing the embodiments may also be transmitted over transmission communication media. Examples of the computer-readable recording media include a magnetic recording apparatus, an optical disk, a magneto-optical disk, and/or a semiconductor memory (for

example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the

described features, functions and/or operations can be provided.

What is claimed is:

1. A method of operating an apparatus having a display device for analyzing a plurality of images each representing a similar item, comprising the steps of:
displaying the plurality of the images in parallel by the display device;
enabling a user to select partial regions of the images such that each of the partial regions represents a similar portion of said each item;
extracting information associated with each of the partial regions of the images; and
displaying data of the information of each of the partial regions in parallel in a format different from that appeared in the images.

2. The method according to claim 1, wherein the step of extracting extracts the information by calculating distribution of color of the partial regions.

3. The method according to claim 1, wherein each of the images has association information, further comprising the steps of determining a correlation between the information of the images and the association information of the images.

4. The method according to claim 3, further comprising the step of generating a distribution diagram illustrating the relationships of the correlation.

5. The method according to claim 1, wherein the step of extracting further executes a process including, obtaining a first partial region of one of the plurality of images, and determining a second partial region of another of the plurality of images on the basis of a position of the first partial region of the image.

6. An apparatus having a display device for analyzing a plurality of images each representing a similar item, comprising:
a controller for executing a process comprising:
displaying the plurality of the images in parallel by the display device;
enabling a user to select partial regions of the images such that each of the partial regions represents a similar portion of said each item;
extracting information associated with each of the partial regions of the images; and
displaying data of the information of each of the partial regions in parallel in a format different from that appeared in the images.

7. A computer readable medium storing a program for operating an apparatus having a display device for analyzing a plurality of images each representing a similar item, comprising, the program performing a process comprising the steps of:
displaying the plurality of the images in parallel by the display device;
enabling a user to select partial regions of the images such that each of the partial regions represents a similar portion of said each item;
extracting information associated with each of the partial regions of the images; and
displaying data of the information of each of the partial regions in parallel in a format different from that appeared in the images.
